(19) United States
(12) Patent Application Publication
(10) Pub. No.: US 2008/0064339 A1
(43) Pub. Date: Mar. 13, 2008

(54) Personal protective cellular telephone with GPS system

(76) Inventor: Richard E. Cavalier, Spotsylvania, VA (US)

Correspondence Address: EUGENE H. EICKHOLT, 1119 CAROLINE STREET, FREDERICKSBURG, VA, 22401, US

(21) Appl. No.: 11/516,660

(22) Filed: Sep. 7, 2006

(51) Int. Cl. H04B 7/00; H04M 11/04

(52) U.S. Cl. 455/66.1; 455/404.2

(57) ABSTRACT

This invention relates to personal protective devices, particularly as combined with cellular telephones. In one embodiment of the invention, a cellular telephone is modified to deliver a personal protective spray, such as pepper spray, mace or dog spray. Upon activation of the spray, the cellular telephone automatically alerts law enforcement or other emergency response personnel, such as by dialing 911, “On Star”, or any number chosen by the cellular phone owner. Additionally, the cellular telephone/protective device combination further includes a global positioning system (GPS) enabling emergency response personnel to immediately locate the individual that has activated the system. In another embodiment, a cellular telephone is combined with tools for tradesmen, including a refillable pen, temperature and humidity sensor, a reversible slot/Phillips head screwdriver, an electrical current tester probe, a temperature/humidity sensor with display, and a electrical current indicator. Also included can be a calculator, tape measure, and levels and laser pointer.

### Watanabe which are all incorporated by reference herein.

Other known prior art includes U.S. Pat. No. 4,186,851; U.S. Pat. No. 4,982,645; U.S. Pat. No. 5,429,301; U.S. Pat. No. 5,476,192; and U.S. Pat. No. 5,531,359.

While these devices fulfill their respective, particular objectives and requirements, the aforementioned patents do not disclose a new combination cellular phone and personal defense system. The inventive device includes a cellular telephone having a housing. The housing includes a keypad, a display, an ear piece, a speaker, and an antenna. The cellular telephone has a rechargeable battery disposed within the housing. One side wall of the housing has a recharge port extending inwardly thereof. A personal defense system is incorporated into the housing of the cellular telephone.

In these respects, the combination cellular phone and personal defense system according to the present invention substantially departs from the conventional concepts and designs of the prior art, and in so doing provides an apparatus primarily developed for the purpose of providing a means of communication and a means of self-defense in one unit.

U.S. Pat. No. 5,988,450, issued to Cassarino, the disclosure of which is fully incorporated herein, provides a combination cellular phone and personal defense system construction wherein the same can be utilized for providing a means of communication and a means of self-defense in one unit. To attain this, the Cassarino device combines a cellular telephone having a housing. The housing includes a keypad, a display, an ear piece, a speaker, and an antenna. The cellular telephone has a rechargeable battery disposed within the housing. One side wall of the housing has a recharge port extending inwardly thereof. A personal defense system is incorporated into the housing of the cellular telephone. The personal defense system includes a cartridge of pepper spray disposed interiorly of the housing. The cartridge is in communication with a nozzle extending outwardly of a side wall of the housing. The nozzle is in communication with an activation switch disposed within the side wall of the housing. The activation switch is in communication with a safety switch disposed within the side wall of the housing. However, unlike the instant invention, the Cassarino device does not alert emergency response personnel, nor does it include a GPS system to automatically locate the individual in distress.

### BRIEF DESCRIPTION OF THE DISCLOSURE

In one embodiment disclosed herein, a conventional cellular telephone is combined into a single, integral unit with a personal protection spray, for example pepper spray. Mace spray or spray intended to deter canines are further examples. Pepper spray of this type is well known in the art, for instance as shown in U.S. Pat. No. 5,988,450 to Cassarino, fully incorporated herein by reference. The cellular phone of the instant invention includes a keypad, a display, an ear piece, a speaker, and an antenna. The cellular telephone has a rechargeable battery disposed within the housing. One side wall of the housing has a recharge port extending inwardly thereof, but it is expressly understood that the recharge port could be positioned in any convenient position on the outer surface of the cellular telephone, and the exact positioning of the recharge port is not critical to the practice of the invention. The personal defense system is incorporated into the housing of the cellular telephone. Located in the center of the exterior housing of the cellular telephone is an activation button, which directly dials “911” or other appropriate numbers as selected for the particular intended use. Should the cellular telephone be particularly adapted for individual business or such, the phone might for instance directly contact a central security agency or in-house security. In that manner, sales personal could easily carry the device and alert security of imminent dangers, such as shoplifting. Airport personal could use the device to alert airport security to suspected terrorism, or the like. It is understood that the term “911” as used herein is intended to include any emergency response to which the cellular telephone could be particularly adapted.

Upon activation of the pepper spray, or other security device, such as a taser, the “911” call is automatically initiated. Such taser devises are fully disclosed in U.S. Pat. No. 5,988,450. By activating the personal protective device, emergency assistance is thus automatically summoned. Even if the user is rendered incapable of summoning assistance, whenever the personal protective device is activated, emergency assistance is summoned. In this manner, a single button can be depressed initiating both the personal protective device and alerting emergency personal for assistance. All the user need do is aim the device and press the button.

Additionally, a global positioning system (GPS) is included, and is also activated upon utilization of the particular personal protective system with which the combination is provided. For instance, when pepper spray is initiated, not only is “911” automatically dialed, but a GPS positioning system is also activated. As a result the individual in danger can be located, even if they are completely incapacitated. Such GPS systems are well known in the art, as described in published U.S. Patent Application 60/493,943, fully incorporated herein by reference.

It is also contemplated that the cellular protective device of the invention could further include a conventional or battery operated whistle, to alert local personal to the imminent threat of danger to the user. A strong light, or laser light, might also be included, as well as an alarm button. Further, a disposable handcuff might be included, that could be pulled from the body of the housing. A small pen might be disposed within the housing, to enable the user to quickly write down for instance a license number of an automobile in an emergency response. Small latex gloves might also be included in the housing, such that they may be quickly pulled out when encountering a suspect, as for instance when the device is used by law enforcement personal. Space for additional batteries is also contemplated.

### DESCRIPTION OF THE DRAWINGS

Referring to FIG. 1, a cellular phone is shown in folded position as it would normally be stored. Element (1) identifies a speaker. The speaker can also be seen as (14) in FIG. 4. Pepper spray canister (5) is removably inserted into a corresponding registered opening. The canister (5) can be screwed into suitable engaging threads to securely attach the cartridge into the telephone, and can be easily removed as shown in FIG. 2. A conventional display is shown as (3), in this case the emergency number 911. Protective cap (7) is tethered to the cellular telephone through tether (6), and can be snapped into place over the removable spray cartridge, including spray button (5), using detents coaxially arranged around cap (7) as shown in (8). Flange (9) is a tab for quick opening and extends past the lower base of cap (7) to enable easy and rapid removal of cap (7).

Again referring to FIG. 1, element (4) is a standard telescoping, retractable antenna unit. High intensity light can be used to further discourage a would-be attacker, as well as direct the spray so the defender doesn't spray himself. Button (5) releases the pepper spray; button 5 is surrounded by a shield as shown in FIG. 1 to prevent accidental discharge. Activation of the pepper spray or light automatically and simultaneously alerts emergency systems through 911. Of course, a signal that can be located through a GPS system is also anticipated, sent through antenna (4), so that emergency response personnel can immediately locate the individual in distress.

Element (10) as seen in FIG. 2 depicts an ON/OFF switch for light (1), shown in Figure (1).

As seen in FIG. (3), element (11) shows snapping element (8) from FIG. 1 in the engaged position, securely fixing the cap (7) in the closed position. A normal electrical connection (12) enables attachment to headphones, for hands-free input, as is conventionally known in the cellular phone art.

Referring to FIG. 4, the cellular telephone is open in the manner of a cellular telephone when in use. Element (14) shows a microphone for outgoing communication. Element (13) is the usual speaker or earpiece to hear the caller during an incoming call. Element (15) shows an optional GPS that can be activated when the pepper spray or other defensive system is engaged, through electrical sensors well known in the art. For instance, depression of the button (5) could engage an electrical contact found on the side of the button (5) and the interior surface of the body, thereby completing an electrical circuit for activating the GPS system. Although the cellular phone shown in the drawings incorporates a pepper spray, it is expressly understood that the invention is not limited in scope to pepper sprays. Other self-defense weapons, such as a taser device, stun gun, or tear gas, are considered viable elements to be combined with the cellular phone. Such weapons are well known in the art and the ordinary artisan could readily select and combine these with the cellular phone, with or without a GPS system.

FIGS. 5-9 show another embodiment of the cellular telephone system. In this embodiment, specifically adapted for the tradesman, numerous convenient features are added to the basic cellular telephone. Referring to FIG. 5, a temperature and humidity/display is seen as (23). A sensor designated as element (19) measures temperature and humidity, best seen in FIG. 6. Such sensors are well known in the art and the specific sensor is not critical to the practice of the invention. The major requirements for the sensor, as with all the elements of the combination, is that the sensor be of a size that can be incorporated into the cellular telephone case.

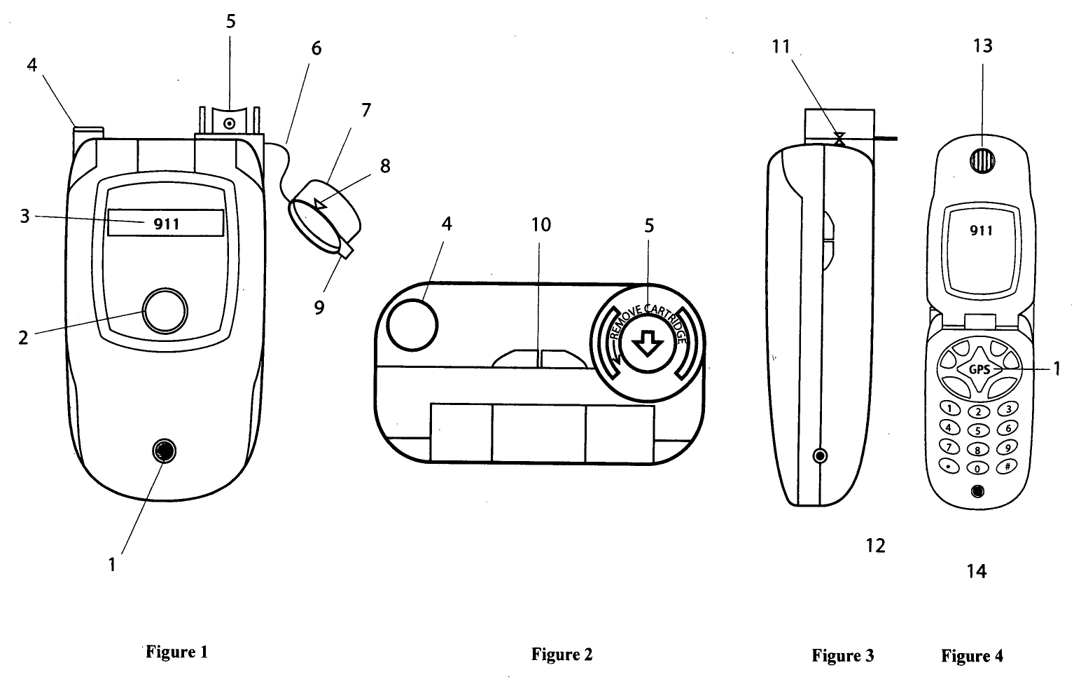

A calculator and formula display, as seen in FIG. 5, is designated as element (25). A cell phone speaker is provided at (26). A bubble-type or laser level, to measure deviations from horizontal, is shown at (27). Another bubble-type level is provided at (31). A conventional cellular phone ear-piece is shown as (28). An electrical current test probe, conventionally known in the art, is provided as element (22), which is rotatable in the direction shown in FIG. 5. Current is detected with the LED designated as (24).

Referring to FIG. (6), a high-intensity light source is provided at (15). The unit is turned on or off with On/Off switch or button (16). A refillable pen, or permanent marker such as a SHARPIE® is removable and designated as (18), best seen in FIG. (7). The unit is powered by batteries that can be recharged using a conventional battery re-charger, with re-charger input (20). A Reversible Slot/Phillips screwdriver is provided at (21).

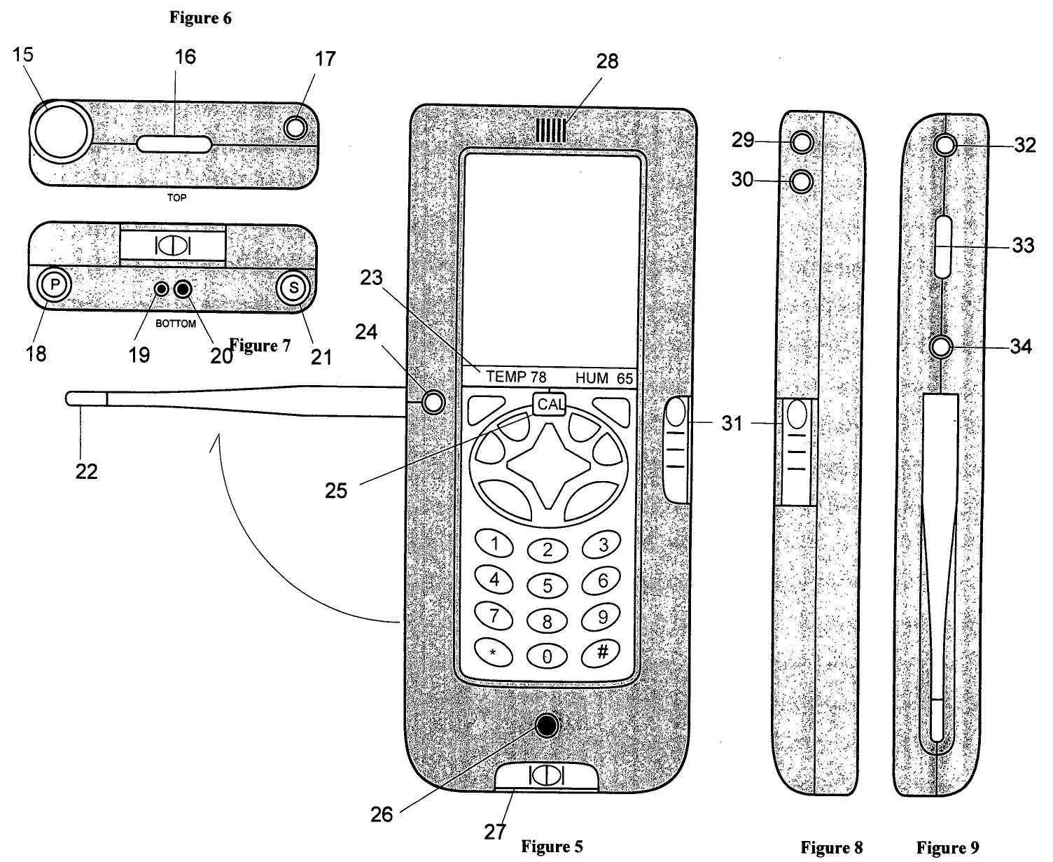

Shown in FIG. 6 is a laser or retractable tape measure, designated as (30). Button (29) enables retraction and release of the tape measure (30). A laser pointer is operated by On/Off button (30), as shown in FIG. (8). Element (33) is a two-way talk button, as normally seen with two-way radio devices. Element (34) is an input for external speaker/microphones, enabling hands-free operation.

1. A cellular telephone comprising a power supply, a microphone for outgoing voice transmission, a speaker for incoming voice amplification, and a personal defense system selected from the group consisting of pepper spray, dog spray, mace, and taser, wherein the battery power supply, microphone, speaker, and personal defense system are assembled in a single housing.

2. The cellular telephone of claim 1 wherein the power supply is a battery.

3. The cellular telephone of claim 1 further comprising a GPS (global positioning system) signal, that is activated upon initiation of the personal defense system, whereby emergency response personnel can readily respond to the exact location of an attack.

4. The cellular telephone of claim 3 wherein the power supply is a battery.

5. The cellular telephone of claim 3 including an antenna that both transmits and receives a telephonic signal, and also transmits an emergency symbol to a satellite GPS system.

6. The cellular telephone of claim 3 wherein the personal defense system automatically alters a 911 emergency system in the event the personal defense system is initiated.

7. The cellular telephone of claim 1 wherein the personal defense system is pepper spray, the pepper spray disposed in a canister that is removable located in a well provided in the housing.

8. The cellular telephone of claim 1 further including a laser light to illuminate an attacker, facilitating initiation of the personal defense system, and discourage a potential attack.

9. The cellular telephone of claim 7 wherein the canister is threaded on one end and corresponding threads are provided in the inside surface of the well, whereby the canister can be threadeningly attached to the housing.

10. The cellular telephone of claim 9 wherein a removable cap is attached to the canister, the cap further provided with a flange to enable easy removal in an emergency situation, and wherein detents are provided on the inside surface of the cap, and corresponding slots for the detents are provided on the outside surface of the canister, to engage the cap.

11. A integral cellular telephone system comprising a housing, battery power supply, a microphone for outgoing voice transmission, a speaker for incoming voice amplification, an antenna to send and receive a telephone signal, a sensor for indicating a condition of horizontal levelness, and an electrical current test probe, wherein the battery power supply, microphone, speaker, antenna, level sensor, and electrical current test probe are integrally located within the housing.

12. The cellular telephone system of claim 11 further comprising a refillable writing instrument.

13. The cellular telephone system of claim 12 wherein the writing instrument is a Sharpie® pen.

14. The cellular telephone system of claim 11 further comprising a removable screwdriver selected from the group consisting of Phillips® head and regular slot head screwdrivers.

15. The cellular telephone system of claim 11 further including a laser pointer.

16. The cellular telephone system of claim 11 further including a temperature/humidity sensor.

17. The cellular telephone system of claim 16 wherein a light emitting diode is operably engaged with the temperature/humidity sensor, and electrical current sensor.

18. The cellular telephone system of claim 11 wherein the sensor for indicating a condition of levelness is a bubble sensor.

19. The telephone system of claim 11 further including removable latex gloves located within a well formed in the housing.

20. The telephone system of claim 11 further including disposable handcuffs removable located within a well formed in the housing.
